(19) United States
(12) Patent Application Publication
(10) Pub. No.: US 2024/0163745 A1
(43) Pub. Date: May 16, 2024

(54) RACH CONFIGURATION CHANGE WITH L1/L2 SIGNALLING IN L1/L2 CENTRIC MOBILITY

(71) Applicant: Telefonaktiebolaget LM Ericsson (PUBL), Stockholm (SE)

(72) Inventors: Pradeepa Ramachandra, LINKÖPING (SE); Icaro Leonardo Da Silva, SOLNA (SE); Helka-Liina Määttänen, ESPOO (FI)

(21) Appl. No.: 18/552,558

(22) PCT Filed: Apr. 1, 2022
(86) PCT No.: PCT/IB2022/053078

§ 371 Date: Sep. 26, 2023

Related U.S. Application Data
(60) Provisional application No. 63/169,833, filed on Apr. 1, 2021.

(51) Int. Cl. H04W 36/00; H04W 36/04; H04W 80/02

(52) U.S. Cl. CPC H04W 36/0072; H04W 36/0061; H04W 36/04; H04W 80/02

(57) ABSTRACT

A method (1000) by a wireless device (110) includes receiving (1002), from a network node (160), a plurality of random access channel, RACH, configurations. Each RACH configuration is associated with a cell within a plurality of cells that are configured to as target candidate cells for Layer 1 or Layer 2 mobility. The wireless device receives (1004) a Layer 1 or Layer 2 signaling comprising an indication of a change from a source cell to a target cell, and the target cell is one of the cells configured as target candidate cells for Layer 1 or Layer 2 mobility. Based on the indication, the wireless device determines (1006), among the plurality of RACH configurations, a RACH configuration associated with the target cell.

### PRIORITY

This application claims priority to U.S. Patent Provisional Application No. 63/169,833 filed on Apr. 1, 2021, entitled “RACH configuration change with L1/L2 signalling in L1/L2 centric mobility,” the disclosure of which is hereby incorporated by reference.

### TECHNICAL FIELD

The present disclosure relates, in general, to wireless communications and, more particularly, systems and methods for Random Access Channel (RACH) configuration change with Layer 1 (L1) or Layer 2 (L2) signalling in L1/L2 centric mobility.

### BACKGROUND

In Release 17 (Rel-17), Third Generation Partnership Project (3GPP) will standardize what has been called Layer 1 (L1)/Layer 2 (L2) centric inter-cell mobility or L1/L2 inter-cell mobility. This is justified in the Work Item Description (WID) RP-193133 by the fact that, while Release 16 (Rel-16) manages to offer some reduction in overhead and/or latency, high-speed vehicular scenarios (e.g. a user equipment (UE) traveling at high speed on highways) at Frequency Range 2 (FR2) require more aggressive reduction in latency and overhead. This is true not only for intra-cell but also for L1/L2 centric inter-cell mobility.

L1/L2 inter-cell centric mobility allows a UE to receive a L1 or L2 signaling (instead of RRC signaling) indicating a TCI state (e.g. for Physical Downlink Control Channel (PDCCH)) possibly associated to an Synchronization Signal Block (SSB) whose PCI is not necessarily the same as the PCI of the cell the UE has connected to e.g. via connection resume or connection establishment. Moreover, it may be the case that the frequency band and/or SSB Absolute Radio Frequency Channel Number (ARFCN) of the current serving cell is also changed during the L1/L2 mobility procedure.

FIG. 1 illustrates the path of a UE at different moments in time (i.e., T1, T2, T3, T4, and T5, as it passes through different coverage areas of different SSBs associated to different PCIs. The PCIs may be associated to the same cell or different cells. Current agreements that have been made concerning this feature may be round in RAN1#102e and RAN1#103e.

In L3 mobility, the UE receives an RRCReconfiguration message that includes an Information Element (IE) ReconfigurationWithSync and performs random access in the target cell. The IE ReconfigurationWithSync can include a contention-free random access (CFRA) configuration to speed up the access in the target cell. The CFRA is defined by at least the set of parameters/fields in the RACH-ConfigDedicated IE that is discussed in 3GPP TS 38.331 16.4.1. The parameter/IE RACH-ConfigDedicated comprises random access (RA) configuration to be used for the reconfiguration with sync such as during handover, for example. The UE performs the RA according to these parameters in the first active UL bandwidth part (BWP) (firstActiveUplinkBWP, see UplinkConfig). Two configurations are provided, one for UL and another one for the supplementary UL (SUL) in 3GPP TS 38.331 16.4.1.

In a system based on beamforming, synchronization signal blocks (SSBs) and/or Channel State Information-Reference Signals (CSI-RSs) can be beamformed in the DL. During a half-frame, different SSBs may be transmitted in different spatial directions using different beams that span the coverage area of a cell. RACH resources, which are indicated in the RACH configuration, can be mapped to DL reference signals, such as SSBs. Then, during the RA procedure (and during the step of Random Access Resource selection, in particular) the UE selects one SSB and/or CSI-RS out of a set of candidates. For example, the UE may select a SSB and/or a CSI-RS based on measurements on these SSBs and CSI-RSs. Based on the selected RS, the UE selects the mapped RACH resource/configuration to be used for the random access procedure. This may include selecting the preamble, for example. In the particular case of CFRA, the UE may be configured to include Layer 3 (L3) filtered beam measurements in an RRC measurement report so that the network can configure CFRA for a subset of SSBs and/or CSI-RS in a target cell and include these configurations in the IE ReconfigurationWithSync.

Certain problems exist, however. For example, there are some questions about RACH configuration in case the serving cell changes:
1. Is there a need for a UE to change a serving cell for DL reception from or UL transmission to another (non-serving) cell, at least on UE-dedicated Physical Downlink Shared Channel (PDSCH), Physical Downlink Control Channel (PDCCH), Physical Uplink Shared Channel (PUSCH), and Physical Uplink Control Channel (PUCCH)?
2. If so, how can the addition, release or change of a non-serving cell for DL reception and/or UL transmission be done? For example, would any of such actions require L3 handover and/or selection/activation among pre-configured candidate cells from RAN2 perspective?
3. If so, how can the TCI states associated with the previous serving cell be handled?
4. If so, what is the impact on the system information reception by the UE?
5. If so, what is the impact on the RACH and PUCCH-related procedures and configurations?
6. If not, what is the impact on the applicable use cases? That is, in what scenarios can the UE be configured for DL reception from or UL transmission to another (non-serving) cell, at least on UE-dedicated PDSCH, PDCCH, PUSCH, and PUCCH, if the serving cell does not change?

It has not been discussed so far how RACH configuration could be handled for L1/L2 mobility, in particular the CFRA. As the UE does not receive an RRC message for performing L1/L2 mobility, it is not possible to use the existing method to include CFRA configuration in the IE ReconfigurationWithSync.

### SUMMARY

Certain aspects of the present disclosure and their embodiments may provide solutions to these or other challenges. For example, according to certain embodiments, methods and systems are provided to enable flexible and efficient signaling to arrange RACH configuration for L1/L2 mobility.

According to certain embodiments, a method by a wireless device includes receiving, from a network node, a plurality of RACH configurations. Each RACH configuration is associated with a cell within a plurality of cells that are configured to as target candidate cells for Layer 1 or Layer 2 mobility. The wireless device receives a L1 or L2 signaling that includes an indication of a change from a source cell to a target cell, and the target cell is one of the cells configured as target candidate cells for L1 or L2 mobility. Based on the indication, the wireless device determines, among the plurality of RACH configurations, a RACH configuration associated with the target cell.

According to certain embodiments, a wireless device is adapted to receive, from a network node, a plurality of RACH configurations. Each RACH configuration is associated with a cell within a plurality of cells that are configured to as target candidate cells for L1 or L2 mobility. The wireless device is adapted to receive a L1 or L2 signaling that includes an indication of a change from a source cell to a target cell, and the target cell is one of the cells configured as target candidate cells for Layer 1 or Layer 2 mobility. Based on the indication, the wireless device is adapted to determine, among the plurality of RACH configurations, a RACH configuration associated with the target cell.

According to certain embodiments, a method by a network node includes transmitting, to a wireless device, a plurality of RACH configurations. Each RACH configuration is associated with a cell within a plurality of cells that are configured as target candidate cells for L1 or L2 mobility. The network node transmits, to the wireless device via L1 or L2 signaling, an indication of a change from a source cell to a target cell, and the indication enables the wireless device to determine, among the plurality of RACH configurations, a RACH configuration associated with the target cell.

According to certain embodiments, a network node is adapted to transmit, to a wireless device, a plurality of RACH configurations. Each RACH configuration is associated with a cell within a plurality of cells that are configured as target candidate cells for L1 or L2 mobility. The network node is adapted to transmit, to the wireless device via L1 or L2 signaling, an indication of a change from a source cell to a target cell, and the indication enables the wireless device to determine, among the plurality of RACH configurations, a RACH configuration associated with the target cell.

Certain embodiments may provide one or more of the following technical advantages. For example, one technical advantage may be that certain embodiments enable flexible and efficient signalling to arrange RACH configuration for L1/L2 mobility. As another example, a technical advantage may be that certain embodiments may make it possible to indicate a previously configured CFRA configuration via lower layer (such as Layer 1 or Layer 2) signaling, which has a lower processing time than RRC messages. As still another example, a technical advantage may be that certain embodiments may not require the involvement of a Centralized Unit in a CU/DU split deployment and, as a result, certain embodiments may speed up the inter-cell procedure.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates the path of a UE at different moments in time as it passes through different cells associated with different PCIs;

FIG. 2 illustrates an example Synchronization Signal Block (SSB), according to certain embodiments;

FIG. 3 illustrates an example wireless network, according to certain embodiments;

FIG. 4 illustrates an example network node, according to certain embodiments;

FIG. 5 illustrates an example wireless device, according to certain embodiments;

FIG. 6 illustrates a virtualization environment in which functions implemented by some embodiments may be virtualized, according to certain embodiments;

FIG. 7 illustrates a telecommunication network connected via an intermediate network to a host computer, according to certain embodiments;

FIG. 8 illustrates a generalized block diagram of a host computer communicating via a base station with a user equipment over a partially wireless connection, according to certain embodiments;

FIG. 9 illustrates a method implemented in a communication system, according to one embodiment;

FIG. 10 illustrates another method implemented in a communication system, according to one embodiment;

FIG. 11 illustrates another method implemented in a communication system, according to one embodiment;

FIG. 12 illustrates another method implemented in a communication system, according to one embodiment;

FIG. 13 illustrates an example method by a wireless device, according to certain embodiments; and

FIG. 14 illustrates an example method by a network node, according to certain embodiments.

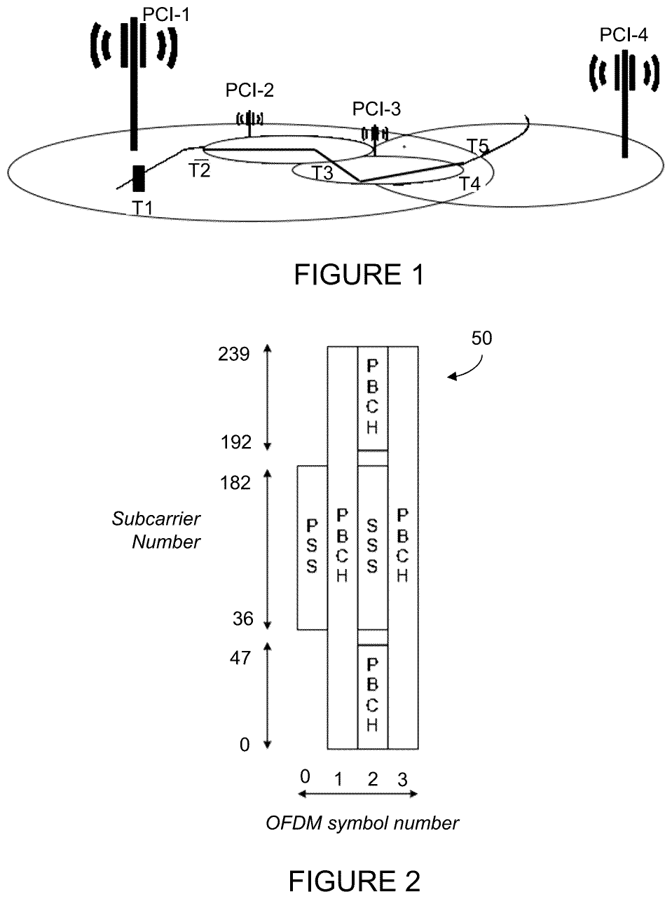

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Additionally, terminologies such as base station/gNB and UE should be considered non-limiting and do in particular not imply a certain hierarchical relation between the two; in general, “gNB” could be considered as device 1 and “UE” could be considered as device 2 and these two devices communicate with each other over some radio channel. And in the following the transmitter or receiver could be either gNB, or UE.

The term “beam” used in the text can correspond to a reference signal that is transmitted in a given direction. For example, if may refer to an SS/PBCH Block (SSB) or layer 3 configured CSI-RS. During a half-frame, different SSBs may be transmitted in different spatial directions (i.e. using different beams, spanning the coverage area of a cell).

The term PCI and/or PCI of an SSB is used and may correspond to the physical cell identity encoded by a Primary Synchronization Sequence (PSS) and an a Secondary Synchronization Sequence (SSS) that are comprised in an SSB. FIG. 2 illustrates an example SSB 50, as defined in 3GPP TS 38.211. The PSS and SSS encode a PCI.

Certain embodiments relate to “cells” or a “set of cells” for which the UE can be configured with to perform L1/L2 centric mobility. These set of cells may be called a set of intra-frequency neighbour cells and are cells on which the UE performs measurements and to which the UE can perform a handover/reconfiguration with sync. Alternatively, these sets of cells may be a set of intra-frequency non-serving cells or simply a set of non-serving cells (in addition to the serving cell). As still another alternative, these sets of cells may be the cells that the UE can use to perform L1 based mobility and can be called candidate SpCells, additional SpCells, the SpCell and non-serving cells (configured candidates for L1 based mobility), etc.

Any ASN1 encoding presented herein is a modification of and/or builds upon 3GPP TS 38.331, which relates to the Rel-16 specifications for RRC. 3GPP TS 38.311 provides a reference for Information Elements (IEs) and fields in the messages and/or IEs herein and any proposed modifications thereto are intended to implement the methods and techniques described herein. However, it is recognized that these are merely provided as examples and the actual implementation of such signaling in the specification may differ.

The term CORESET refers to a Control Resource Set, as defined in 3GPP TS 38.300. A UE monitors a set of PDCCH candidates in the configured monitoring occasions in one or more configured COntrol REsource SETs (CORESETs) according to the corresponding search space configurations. A CORESET consists of a set of Physical Resource Blocks (PRBs) with a time duration of 1 to 3 Orthogonal Frequency Division Multiplexing (OFDM) symbols. The resource units Resource Element Groups (REGs) and Control Channel Elements (CCEs) are defined within a CORESET with each CCE consisting of a set of REGs. Control channels are formed by aggregation of CCE. Different code rates for the control channels are realized by aggregating different number of CCE. Interleaved and non-interleaved CCE-to-REG mapping are supported in a CORESET.

Certain embodiments may be described as including that the “UE receives” a message such as, for example, a MAC CE. This may correspond to the UE receiving a network function from a network node, such as a DU of a gNodeB in a Next Generation Radio Access Network (NG-RAN), or a CU, or a node performing a Baseband functionality.

Herein, the terms “Layer 1 (L1) or Layer 2 (L2) signalling” and “L1/L2 signalling” are interchangeably used. Likewise, herein, the terms “L1/L2 mobility” and “L1 or L2 mobility” are interchangeably used, and the terms “L1/L2 mobility procedure” and “L1 or L2 mobility procedure” are interchangeably used.

According to certain embodiments, methods and systems are provided to enable flexible and efficient signaling to arrange RACH configuration for L 1/L2 mobility. For example, the UE receives an arranged and divided RACH specific configuration(s) for the cells or PCIs among which the UE performs the L1/L2 mobility in such a way that a switching between the applied configurations becomes possible when the UE receives L2 signalling (MAC CE), for e.g. L1 based mobility. Further, the overall RACH configuration can be categorized to a part that remains fixed while the UE does L1/L2 mobility and a part that is per cell/PCI from which the UE receives data from. According to certain embodiments, the method may also include selecting, by the UE, a RACH configuration, determining whether it needs to perform RA during L1 based mobility based on conditions related to “beam alignment” and/or time alignment of the target cell/PCI for L1 based mobility.

According to certain embodiments, a method includes the network node transmitting to the UE one or more RACH configurations to be flexibly applied by the UE for the L1/L2 inter-cell mobility. The network arranges and divides RACH specific configurations for the cells or PCIs among which the UE should perform the L1/L2 mobility in such a way that a switching between the applied configurations becomes possible when the network transmits signalling such as, for example, a MAC CE for the L1 based mobility.

For example, in a particular embodiment, the network node may transmit a list of RACH configurations per cell/PCI where each configuration is self-contained for that PCI/cell (i.e. the each configuration is associated with a PCI/cell). Alternatively, the network node may transmit one overall configuration of shared RACH configuration parameters and either list of RACH sub-configurations per cell/PCI, or lists of specific parameters or IEs that are then different for different PCI/cell. In still another embodiment, the network node may transmit a MAC CE that indicates the changing part of the RACH configuration, or part of it. In still another particular embodiment, the network node may transmit a MAC CE that updates a certain association between a RACH configuration or part of it for a cell/PCI and a parameter or IE. In still another particular embodiment, the overall RACH configuration can be categorized to a part that remains fixed while the UE does L1/L2 mobility and a part that is per cell/PCI from which the UE receives data from.

In a particular embodiment, the network node may monitor these resources depending on the L1 based mobility procedures. For example, if the network configures the UE with CFRA config (1) associated to cell-A and CFRA config (2) associated to cell-B, while the UE is connected to cell-C (e.g. PCell is cell-C) the network does not need to monitor CFRA config (1) or CFRA config (2). Then, when the network transmits to the UE a MAC CE for L1 based mobility, associated to a target cell (cell-B) the network monitors CFRA config (2). According to certain embodiments, the method may also include selecting, by the network node, which CFRA configuration to point to the UE based on measurements reported by the UE before the network decides the target cell/target TCI state to indicate the MAC CE for L1 based mobility. The method may also include determining, by the network, whether it needs to indicate the UE a random access configuration during Ll based mobility, based on network assumptions for the UE concerning “beam alignment” with the target cell/PCI and/or time alignment of the target cell/PCI for L1 based mobility.

According to certain embodiments, the UE receives the RACH configurations from the network node and then selects one of the RACH configurations for the L1/L2 mobility. In particular, the UE may determine whether it needs to perform RA during L1 based mobility based on conditions related to “beam alignment” and/or time alignment of the target cell/PCI for L1 based mobility.

According to certain embodiments, the RACH configurations may be provisioned for all cells/PCIs involved in the L1/L2 mobility. This may be performed by the network node providing a list of RACH configurations per cell or per PCI such that each configuration is self-contained for that PCI/cell. In a particular embodiment, the list of RACH configurations may be provided per cell or per PCI. Specifically, the list of PRACH configurations may be provided for the UE for all the cells involved in the L1-L2 mobility.

An example for providing RACH configuration list directly an RRCReconfiguration message, is shown below:

| | |
|---|---|
| ReconfigurationWithSync ::= | SEQUENCE { |
| spCellConfigCommon | ServingCellConfigCommon |

OPTIONAL, -- Need M

| | |
|---|---|
| newUE-Identity | RNTI-Value, |
| t304 | ENUMERATED {ms50, ms100, ms150, ms200, ms500, ms1000, |

ms2000, ms10000},

| | |
|---|---|
| rach-ConfigDedicated | CHOICE { |
| uplink | RACH-ConfigDedicated, |
| supplementaryUplink | RACH-ConfigDedicated |

```
  }
OPTIONAL, -- Need N
  ...,
  [[
```

| | |
|---|---|
| smtc | SSB-MTC |

```
OPTIONAL -- Need S
  ]],
  [[
```

| | |
|---|---|
| daps-UplinkPowerConfig-r16 | DAPS-UplinkPowerConfig-r16 |

OPTIONAL -- Need N
]],
[[

| | | |
|---|---|---|
| rachConfigDedicatedList-r17 | RACHConfigDedicatedList-r17 | OPTIONAL --Need M |

]]
}
RACHConfigDedicatedList-r17 ::= SEQUENCE (SIZE (1..maxNofCell-r17)) OF RACHConfigperCell
RACHConfigperCell ::= SEQUENCE {
RACHConfigId id
L1MobilityCellId id
Rach-ConfigDedicated RACH-ConfigDedicated
}

In the above configuration, the LIMObilityCellID is needed as it is associated with a corresponding PCI and therefore a corresponding SSB-burst. Then, within RACH-ConfigDedicated, which is an existing IE in 3GPP TS 38.331, SSBIndex is given in a sub IE CFRA-SSB-Resources which points the UE the SSB to be used as RACH resource. The LIMObilityCellID would give the PCI associated to the SSB given in the SSBIndex.

If, additionally, the RACHConfigId is present, it enables the network node to give more than one detailed RACH configuration for one cell/PCI.

According to some embodiments, some examples of a MAC CE are as follows:
1. A MAC CE that switches the UE from one L1MobilityCell to another. This MAC CE needs to contain a PCI or an identifier (ID) that is mapped in RRC to the PCI of the cell to which the L1 mobility can be performed. This MAC CE may switch all RRC configurations of the UE that are needed for operating to/from the new cell/PCI including the RACH configuration.
2. MAC CE (or part of it) that switches only the RACH configuration related to a cell/PCI UE to which the L1/L2 mobility is performed. This MAC CE needs to include the RACHConfigID.
3. A MAC CE that does not perform Ll mobility but updates for the mapping between L1 mobilityCellId and RachConfigID. This MAC CE needs to contain both of these fields and it updates the association given by RRC.
   One overall configuration of the shared RACH configuration parameters includes a list of RACH subconfigurations per cell/PCI or lists of specific parameters or IEs that are then different for different PCIs/cells.

In a particular embodiment, the RACH-Config dedicated contains shared configuration for all cell/PCIs involved in the L1 mobility and sub-configurations per cell/PCI.

An example of such a configuration is included in the below ASN1:

```
    - RACH-ConfigDedicated
The IE RACH-ConfigDedicated is used to specify the dedicated random access parameters.
              RACH-ConfigDedicated information element
-- ASN1START
-- TAG-RACH-CONFIGDEDICATED-START
```

| | |
|---|---|
| RACH-ConfigDedicated ::= | SEQUENCE { |
| cfra | CFRA |

OPTIONAL, -- Need S

| | |
|---|---|
| ra-Prioritization | RA-Prioritization |

```
OPTIONAL, -- Need N
  ...,
  [[
```

| | |
|---|---|
| ra-PrioritizationTwoStep-r16 | RA-Prioritization |

OPTIONAL, -- Need N

| | |
|---|---|
| cfra-TwoStep-r16 | CFRA-TwoStep-r16 |

OPTIONAL -- Need S
]],
[[
cfraList CFRALIst OPTIONAL
]]
}
CFRAList ::= SEQUENCE (SIZE (1..maxNofCell-r17)) OF CFRA

| | |
|---|---|
| CFRA ::= | SEQUENCE { |
| occasions | SEQUENCE { |

| | |
|---|---|
| rach-ConfigGeneric | RACH-ConfigGeneric, |

```
                    **omitted**
  ...,
  [[
  totalNumberOfRA-Preambles INTEGER (1..63)
OPTIONAL -- Cond Occasions
  ]]
[[
```

| | |
|---|---|
| L1MobilityCellId | id |

]]
}

| | |
|---|---|
| CFRA-TwoStep-r16 ::= | SEQUENCE { |
| occasionsTwoStepRA-r16 | SEQUENCE { |
| rach-ConfigGenericTwoStepRA-r16 | RACH-ConfigGenericTwoStepRA-r16, |
| ssb-PerRACH-OccasionTwoStepRA-r16 | ENUMERATED {oneEighth, oneFourth, oneHalf, one, |
| | two, four, eight, sixteen} |

```
  }
                    **omitted**
}
```

| | |
|---|---|
| CFRA-SSB-Resource ::= | SEQUENCE { |
| ssb | SSB-Index, |
| ra-PreambleIndex | INTEGER (0..63), |

```
  ...,
  [[
  msgA-PUSCH-Resource-Index-r16  INTEGER (0..3071)  OPTIONAL -- Cond 2StepCFRA
  ]],
[[
```

| | |
|---|---|
| ra-PreambleIndexList | RA-PreambleIndexList |

]]
}
RA-PreambleIndexList ::= SEQUENCE (SIZE (1..maxNPreamble-r17)) OF INTEGER (0..63)

| | |
|---|---|
| CFRA-CSIRS-Resource ::= | SEQUENCE { |
| csi-RS | CSI-RS-Index, |
| ra-OccasionList | SEQUENCE (SIZE (1..maxRA-OccasionsPerCSIRS)) OF INTEGER |

(0..maxRA-Occasions−1),

| | |
|---|---|
| ra-PreambleIndex | INTEGER (0..63), |

...
}
-- TAG-RACH-CONFIGDEDICATED-STOP
-- ASN1STOP

In the above RRC example, the SSB index in CFRA-SSB-Resource refers to the SSB of the SSB burst associated to PCI which is associated to L1MobilityCellId given in IE CFRA. For example, the MAC CE that is transmitted from the network node to the UE in the method described above may operate or trigger the UE to switch from one L1MobilityCell to another. This MAC CE needs to contain a PCI or an ID that is mapped in RRC to the PCI of the cell to which the L1 mobility can be performed. This MAC CE may switch all needed RRC configurations of the UE needed for operating to/from the new cell/PCI, including the RACH configuration.

In another embodiment, a list of specific parameters or IEs that are different for different PCIs/cells is provided. As an example, the RA-preamble may be different. The ASN1 example is given above. This embodiment and the associated example MAC CE may be used together with the embodiments described above.

The related MAC CE example is as follows:
The MAC CE needs to contain L1MobilityCellId or any ID that identifies the RACH configuration or part of it. Additionally the MAC CE needs to contain pairs of an ID or pointer that indicates one of the raPreambles given in the ra-PreambleIndexList and the SSBIndex. In the above example there is no explicit index but the order in the list may be understood as pointer. Thus, given the list of preambles configured and one preamble that is given as the default in the RRC (in this example, the legacy configuration), the MAC CE may select another preamble from the list to be the associated to a given SSBIndex.

In an embodiment, the UE receives an indication of a configured RACH configuration and takes at least one action in response to the indication. For example, the UE may start a timer (possibly pre-configured) and while the timer is running the RACH configuration is valid. For example, the UE can use the configured RACH configuration in the target cell/PCI during or after L1 based mobility. When the timer expires, the UE suspends the configuration. Thus, the UE cannot use the configured RACH configuration except when it receives another MAC CE indicating that same configured RACH configuration again.

In another embodiment, the UE receives an indication of a configured RACH configuration and determines whether the UE needs to perform RA during L1 based mobility, based on at least one of the following conditions (or any combination of these):
If the Time Alignment (TA) timer, associated with the target cell/PCI is running (i.e., UL sync is valid), the UE determines not to use the indicated RACH configuration. Thus, upon receiving an indication to perform L1 based mobility, the UE starts to monitor PDCCH/CORESET according to the indicated TCI state in the received MAC CE;
Alternatively, if the TA timer has expired (i.e., the UL sync is invalid), the UE determines to perform RA with the indicated configuration. According to certain embodiments, a method is proposed at a network node, which may include, for example, any node that corresponds to a gNB in a NG-RAN. The method includes transmitting, by the network node, to a UE, a RACH configuration to be flexibly applied by the UE for the L1/L2 centric inter-cell mobility. The network arranges and divides RACH specific configurations for the cells or PCIs among which the UE should perform the L1/L2 mobility in such a way that a switching between the applied configurations becomes possible when the network node transmits signalling (e.g. MAC CE) such as, for example, for L1 based mobility. The method may also include the network node monitoring these resources depending on the L1 based mobility procedures. For example, if the network node configures the UE with CFRA config (1) associated to cell-A and CFRA config (2) associated to cell-B, while the UE is connected to cell-C (e.g. PCell is cell-C), the network node does not need to monitor CFRA config (1) or CFRA config (2). Then, when the network node transmits to the UE a MAC CE for L1 based mobility, associated to a target cell, the network node monitors CFRA config (2). The method may also include selecting, by the network node, which CFRA configuration to point to the UE based on measurements reported by the UE before the network node decides the target cell/target TCI state to indicate the MAC CE for L1 based mobility. The method may also include determining, by the network node, whether it needs to indicate the UE a random access configuration during L1 based mobility, based on network assumptions for the UE concerning “beam alignment” with the target cell/PCI and/or time alignment of the target cell/PCI for L1 based mobility.

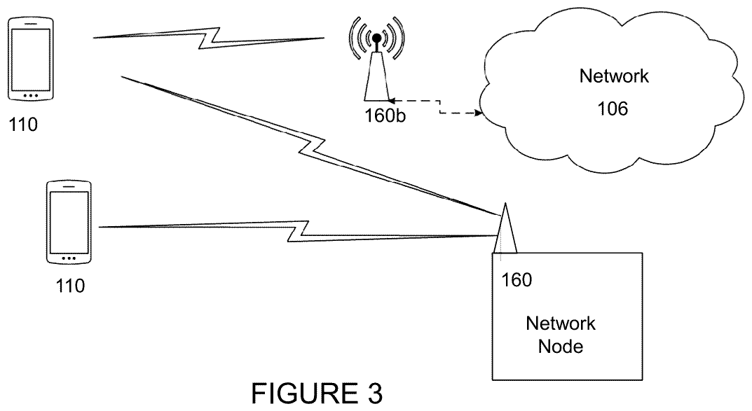

FIG. 3 illustrates a wireless network, according to certain embodiments. Although the subject matter described herein may be implemented in any appropriate type of system using any suitable components, the embodiments disclosed herein are described in relation to a wireless network, such as the example wireless network illustrated in FIG. 3. For simplicity, the wireless network of FIG. 3 only depicts network 106, network nodes 160 and 160b, and wireless devices 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and wireless device 110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

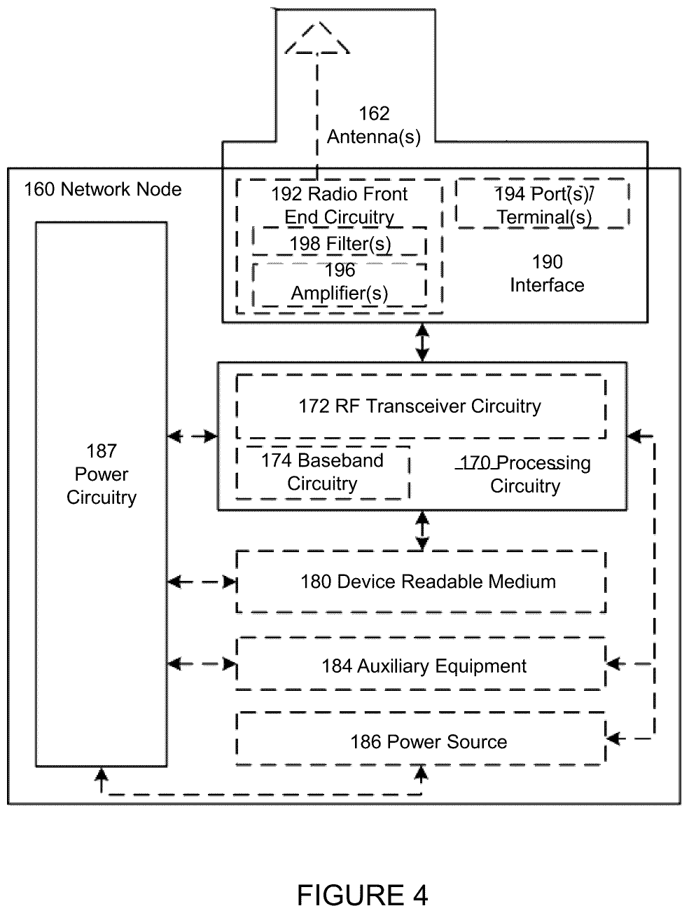

FIG. 4 illustrates an example network node 160, according to certain embodiments. As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 4, network node 160 includes processing circuitry 170, device readable medium 180, interface 190, auxiliary equipment 184, power source 186, power circuitry 187, and antenna 162. Although network node 160 illustrated in the example wireless network of FIG. 4 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

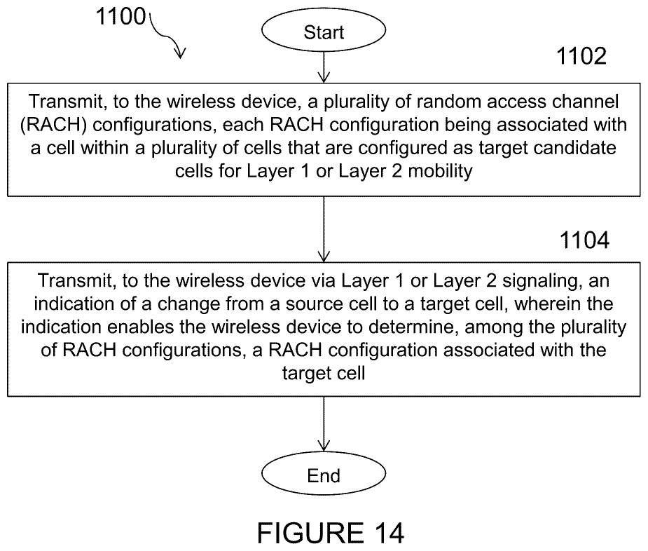

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. For example, the processing circuitry 170 may be configured to perform the method described below with regard to FIG. 14. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units.

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or wireless devices 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or wireless devices via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 4 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

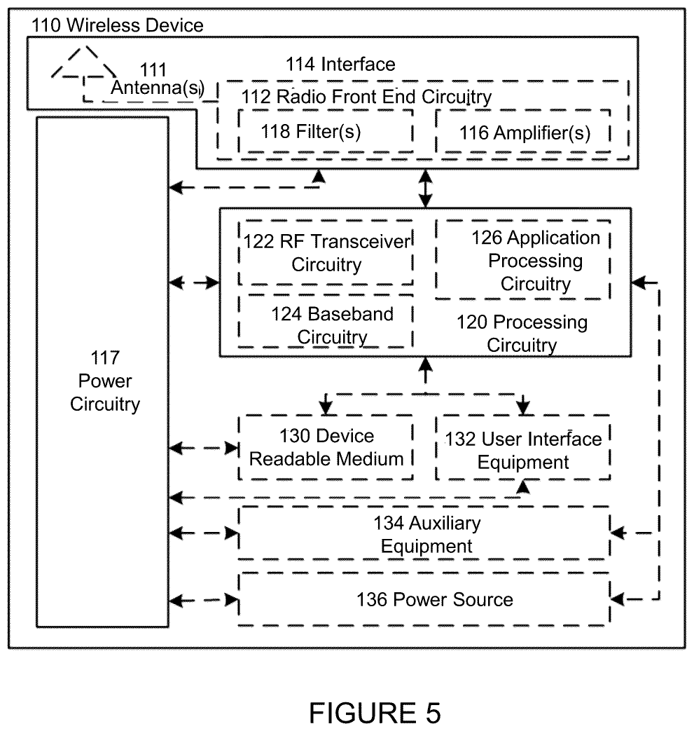

FIG. 5 illustrates an example wireless device 110. According to certain embodiments. As used herein, wireless device refers to a device capable, configured, arranged and/or operable to communicate wirelessly with network nodes and/or other wireless devices. Unless otherwise noted, the term wireless device may be used interchangeably herein with UE. Communicating wirelessly may involve transmitting and/or receiving wireless signals using electromagnetic waves, radio waves, infrared waves, and/or other types of signals suitable for conveying information through air. In some embodiments, a wireless device may be configured to transmit and/or receive information without direct human interaction. For instance, a wireless device may be designed to transmit information to a network on a predetermined schedule, when triggered by an internal or external event, or in response to requests from the network. Examples of a wireless device include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A wireless device may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a wireless device may represent a machine or other device that performs monitoring and/or measurements and transmits the results of such monitoring and/or measurements to another wireless device and/or a network node. The wireless device may in this case be a machine-to-machine (M2M) device, which may in a 3GPP context be referred to as an MTC device. As one particular example, the wireless device may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a wireless device may represent a vehicle or other equipment that is capable of monitoring and/or reporting on its operational status or other functions associated with its operation. A wireless device as described above may represent the endpoint of a wireless connection, in which case the device may be referred to as a wireless terminal. Furthermore, a wireless device as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. Wireless device 110 may include multiple sets of one or more of the illustrated components for different wireless technologies supported by wireless device 110, such as, for example, GSM, WCDMA, LTE, NR, WiFi, WiMAX, or Bluetooth wireless technologies, just to mention a few. These wireless technologies may be integrated into the same or different chips or set of chips as other components within wireless device 110.

Antenna 111 may include one or more antennas or antenna arrays, configured to send and/or receive wireless signals, and is connected to interface 114. In certain alternative embodiments, antenna 111 may be separate from wireless device 110 and be connectable to wireless device 110 through an interface or port. Antenna 111, interface 114, and/or processing circuitry 120 may be configured to perform any receiving or transmitting operations described herein as being performed by a wireless device. Any information, data and/or signals may be received from a network node and/or another wireless device. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, wireless device 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or wireless devices via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

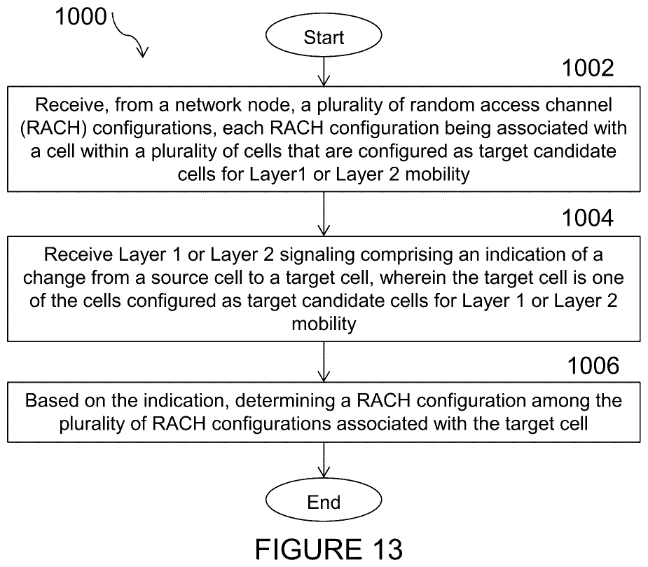

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other wireless device 110 components, such as device readable medium 130, wireless device 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein such as, for example, the method described below with regard to FIG. 13.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of wireless device 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In some embodiments, part or all of RF transceiver circuitry 122 and baseband processing circuitry 124 may be on the same chip or set of chips, and application processing circuitry 126 may be on a separate chip or set of chips. In some embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a wireless device may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of wireless device 110, but are enjoyed by wireless device 110 as a whole, and/or by end users and the wireless network generally.

Processing circuitry 120 may be configured to perform any determining, calculating, or similar operations (e.g., certain obtaining operations) described herein as being performed by a wireless device. These operations, as performed by processing circuitry 120, may include processing information obtained by processing circuitry 120 by, for example, converting the obtained information into other information, comparing the obtained information or converted information to information stored by wireless device 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., RAM or ROM), mass storage media (e.g., a hard disk), removable storage media (e.g., a CD or a DVD), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with wireless device 110. Such interaction may be of many forms, such as visual, audial, tactile, etc. User interface equipment 132 may be operable to produce output to the user and to allow the user to provide input to wireless device 110. The type of interaction may vary depending on the type of user interface equipment 132 installed in wireless device 110. For example, if wireless device 110 is a smart phone, the interaction may be via a touch screen; if wireless device 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into wireless device 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from wireless device 110, and to allow processing circuitry 120 to output information from wireless device 110. User interface equipment 132 may include, for example, a speaker, a display, vibrating circuitry, a USB port, a headphone interface, or other output circuitry. Using one or more input and output interfaces, devices, and circuits, of user interface equipment 132, wireless device 110 may communicate with end users and/or the wireless network and allow them to benefit from the functionality described herein.

Auxiliary equipment 134 is operable to provide more specific functionality which may not be generally performed by wireless devices. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. wireless device 110 may further comprise power circuitry 137 for delivering power from power source 136 to the various parts of wireless device 110 which need power from power source 136 to carry out any functionality described or indicated herein. Power circuitry 137 may in certain embodiments comprise power management circuitry. Power circuitry 137 may additionally or alternatively be operable to receive power from an external power source; in which case wireless device 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of wireless device 110 to which power is supplied.

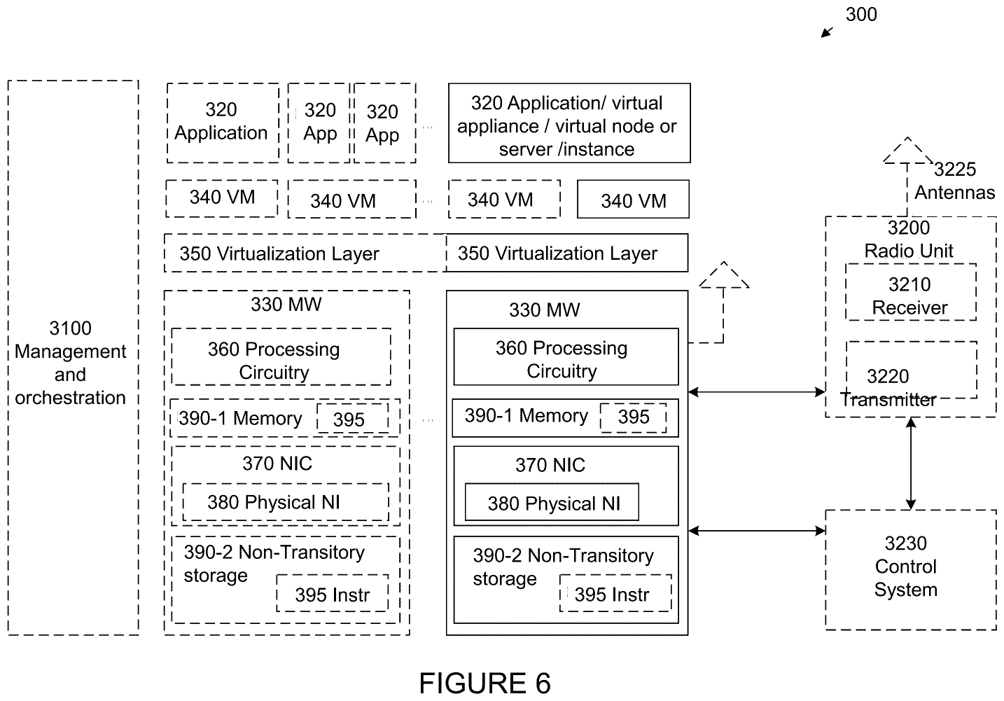

FIG. 6 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 6, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 6.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be affected with the use of control system 3230 which may alternatively be used for communication between the hardware nodes 330 and radio units 3200.

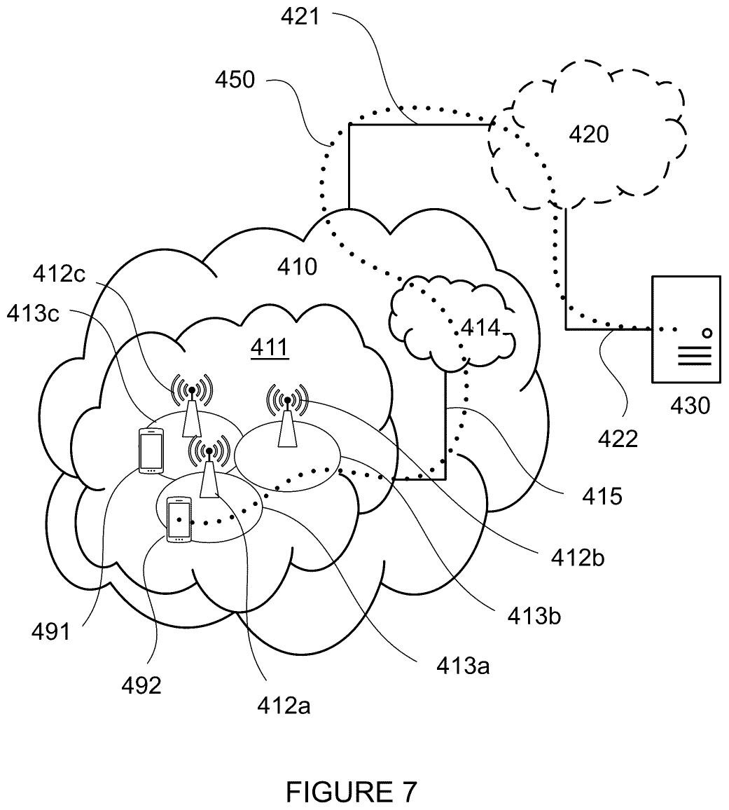

FIG. 7 illustrates a telecommunication network connected via an intermediate network to a host computer in accordance with some embodiments.

With reference to FIG. 7, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 7 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

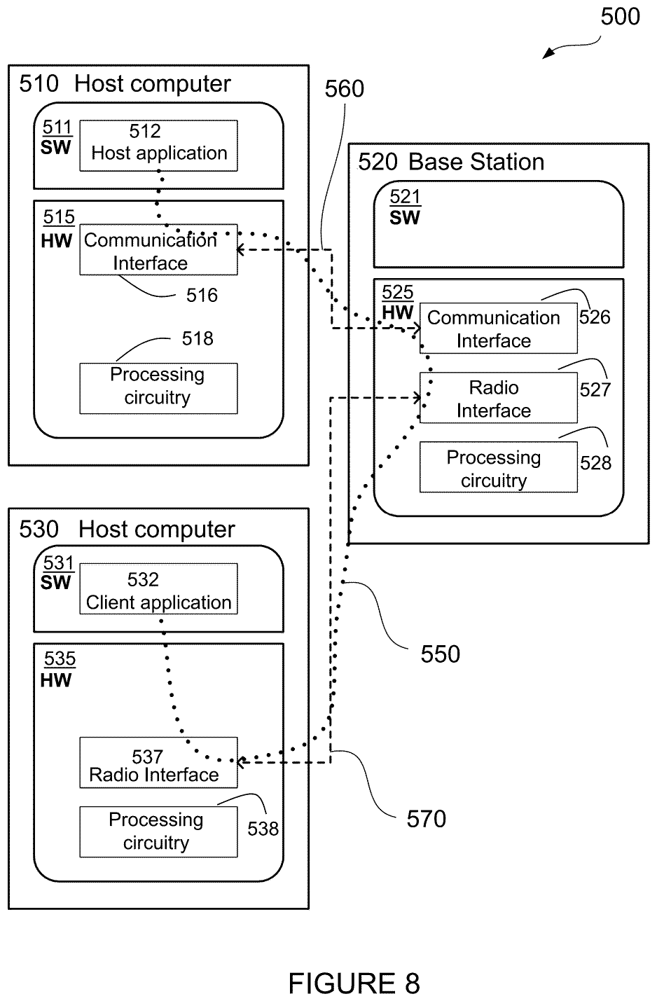

FIG. 8 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 8. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 8) served by base station 520. Communication interface 526 may be configured to facilitate connection 560 to host computer 510. Connection 560 may be direct or it may pass through a core network (not shown in FIG. 8) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 8 may be similar or identical to host computer 430, one of base stations 412a, 412b, 412c and one of UEs 491, 492 of FIG. 7, respectively. This is to say, the inner workings of these entities may be as shown in FIG. 8 and independently, the surrounding network topology may be that of FIG. 7.

In FIG. 8, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the data rate, latency, and/or power consumption and thereby provide benefits such as reduced user waiting time, relaxed restriction on file size, better responsiveness, and/or extended battery lifetime.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510′s measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

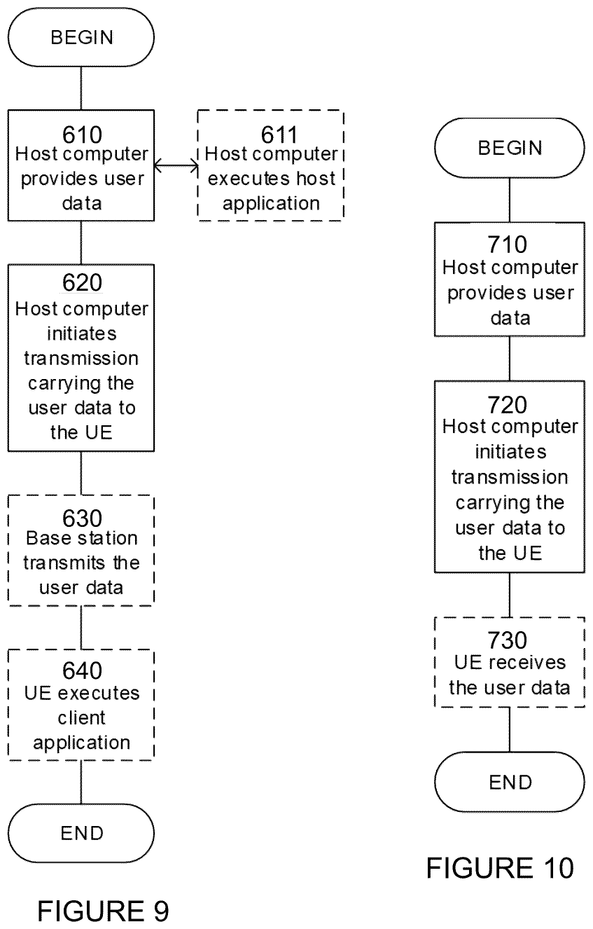

FIG. 9 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 9 will be included in this section. In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 10 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 10 will be included in this section. In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

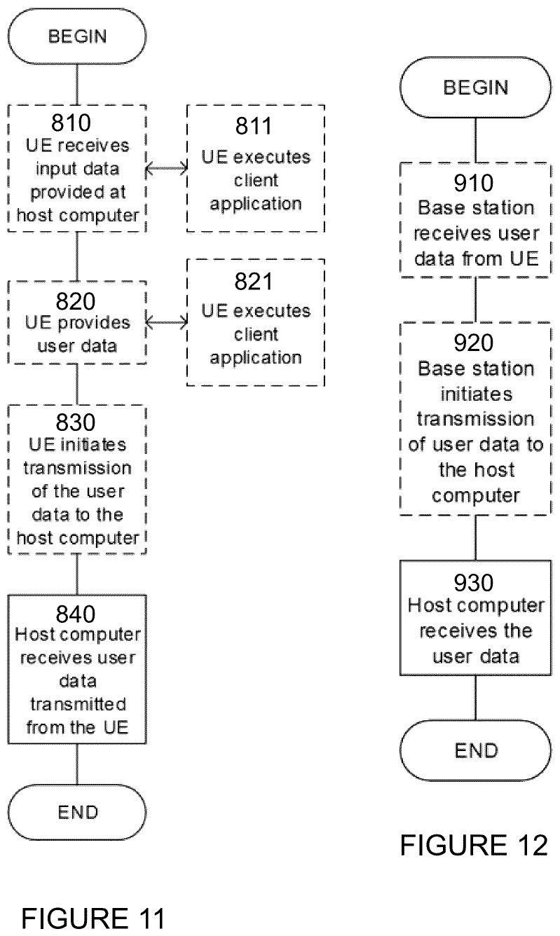

FIG. 11 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 11 will be included in this section. In step 810 (which may be optional), the UE receives input data provided by the host computer. Additionally or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 12 is a flowchart illustrating a method implemented in a communication system, in accordance with one embodiment. The communication system includes a host computer, a base station and a UE which may be those described with reference to FIGS. 7 and 89. For simplicity of the present disclosure, only drawing references to FIG. 12 will be included in this section. In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

FIG. 13 illustrates a method 1000 by a wireless device 110, according to certain embodiments. The method begins at step 1002 when the wireless device 110 receives, from a network node 160, a plurality of RACH configurations. Each RACH configuration being associated with a cell within a plurality of cells that are configured to as target candidate cells for L1 or L2 mobility. At step 1004, the wireless device 110 receives a L1 or L2 signaling comprising an indication of a change from a source cell to a target cell. The target cell is one of the cells configured as target candidate cells for L1 or L2 mobility. Based on the indication, the wireless device 110 determines, among the plurality of RACH configurations, a RACH configuration associated with the target cell.

In a particular embodiment, the L1 or L2 signaling is one of: a mobility signaling indicating a change from the source cell associated with a first PCI to the target cell associated with a second PCI, and a signaling multiplexed with a mobility signaling indicating a change from the source cell to the target cell.

In a particular embodiment, the wireless device 110 performs a random access using the determined RACH configuration.

In a particular embodiment, the wireless device 110 starts a timer upon receiving the plurality of RACH configurations, and the determined RACH configuration is used until the timer expires.

In a particular embodiment, while the wireless device 110 performs the random access using the determined RACH configuration, the wireless device 110 determines that at least one condition is fulfilled and, based on the at least one condition being fulfilled, the wireless device 110 uses the determined RACH configuration.

In a particular embodiment, when determining that the at least one condition is fulfilled, the wireless device 110 determines that a timer associated with the determined RACH configuration is running.

In a particular embodiment, the wireless device 110 determines that the timer associated with the determined RACH configuration has expired and ceases using the determined RACH configuration.

In a particular embodiment, the determined RACH configuration comprises at least one parameter that is applicable to the plurality of cells, and each of the cells is associated with one or more PCIs.

In a particular embodiment, the determined RACH configuration comprises at least one parameter that is applicable only to the target cell that is associated with one or more PCIs.

In a particular embodiment, the plurality of RACH configurations are received via a RRC message.

In a particular embodiment, the wireless devices at least one of: a change to at least a portion of the determined RACH configuration; a change to an association between at least a portion of the determined RACH configuration and a cell or a physical cell identifier, PCI; and/or a change to an association between at least a portion of the determined RACH configuration and a parameter or an information element.

In a particular embodiment, the indication of the change from the source cell to the target cell is received as a MAC CE.

In a further particular embodiment, the MAC CE comprises a cell identifier associated with a new target cell. The wireless device 110 determines a new RACH configuration among the plurality of RACH configurations associated with the new target cell and switches from the target cell to the new target cell.

In a further particular embodiment, the MAC CE comprises a RACHConfigID associated with a new target cell to which the wireless device performs L1 or L2 mobility.

In a further particular embodiment, the MAC CE comprises a mobilityCellID and the RACHConfigID, and the wireless device 110 updates an association between the mobilityCellID and the RACHConfigID.

In a particular embodiment, the wireless device 110 determines not to perform random access when a Time Alignment (TA) timer is running and, upon receiving an indication to perform the L1 or L2 mobility, the wireless device 110 initiates monitoring of a PDCCH and/or CORESET according to an indicated TCI, state.

In a particular embodiment, the wireless device 110 determines to perform random access when the TA timer has expired and, upon receiving an indication to perform the L1 or L2 mobility, the wireless device 110 performs random access with the determined RACH configuration.

FIG. 14 illustrates a method 1100 by a network node 160, according to certain embodiments. The method begins at step 1102 when the network node 160 transmits, to a wireless device 110, a plurality of RACH configurations. Each RACH configuration is associated with a cell within a plurality of cells that are configured as target candidate cells for L1 or L2 mobility. At step 1104, the network node 160 transmits, to the wireless device 110 via L1 or L2 signaling, an indication of a change from a source cell to a target cell, and the indication enables the wireless device to determine, among the plurality of RACH configurations, a RACH configuration associated with the target cell.

In a particular embodiment, at least one RACH configuration within the plurality of RACH configurations comprises at least one parameter that is applicable to the plurality of cells, and each of the cells is associated with one or more PCIs.

In a particular embodiment, at least one RACH configuration within the plurality of RACH configurations comprises at least one parameter that is applicable only to the target cell that is associated with one or more PCIs.

In a particular embodiment, the plurality of RACH configurations are transmitted in a RRC message, a MAC message, and/or a MAC-CE.

In a particular embodiment, the network node 160 transmits, to the wireless device 110, at least one of: a change to at least a portion of at least one RACH configuration; a change to an association between at least a portion of at least one RACH configuration and a cell or a physical cell identifier, PCI; and a change to an association between at least a portion of at least one RACH configuration and a parameter or an information element.

In a particular embodiment, the indication of the change from the source cell to the target cell is transmitted via a MAC CE.

In a further particular embodiment, the MAC CE comprises a cell identifier associated with a new target cell to which the wireless device is to switch, and the network node 160 determines a new RACH configuration among the plurality of RACH configurations associated with the new target cell.

In a further particular embodiment, the MAC CE comprises a RACHConfigID associated with a new target cell to which the wireless device 110 performs Layer 1 or Layer 2 mobility.

In a particular embodiment, the MAC CE comprises a mobilityCellID and the RACHConfigID, and the method comprises updating an association between the mobilityCellID and the RACHConfigID.

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure.

1. A method by a wireless device, the method comprising:
receiving from a network node, a plurality of random access channel, RACH, configurations, each RACH configuration being associated with a cell within a plurality of cells that are configured to as target candidate cells for Layer 1 or Layer 2 mobility;
receiving a Layer 1 or Layer 2 signaling comprising an indication of a change from a source cell to a target cell, wherein the target cell is one of the cells configured as target candidate cells for Layer 1 or Layer 2 mobility; and
based on the indication, determining, among the plurality of RACH configurations, a RACH configuration associated with the target cell.

2.-17. (canceled)

18. A method by a network node, the method comprising:
transmitting, to a wireless device, a plurality of random access channel, RACH, configurations, each RACH configuration being associated with a cell within a plurality of cells that are configured as target candidate cells for Layer 1 or Layer 2 mobility; and
transmitting, to the wireless device via Layer 1 or Layer 2 signaling, an indication of a change from a source cell to a target cell, wherein the indication enables the wireless device to determine, among the plurality of RACH configurations, a RACH configuration associated with the target cell.

19.-26. (canceled)

27. A wireless device adapted to:
receive, from a network node, a plurality of random access channel, RACH, configurations, each RACH configuration being associated with a cell within a plurality of cells that are configured as target candidate cells for Layer 1 or Layer 2 mobility;
receive Layer 1 or Layer 2 signaling comprising an indication of a change from a source cell to a target cell, wherein the target cell is one of the cells configured as target candidate cells for Layer 1 or Layer 2 mobility; and
based on the indication, determine a RACH configuration among the plurality of RACH configurations associated with the target cell.

28. The wireless device of claim 27, wherein the Layer 1 or Layer 2 signaling is one of:
a mobility signaling indicating a change from the source cell associated with a first Physical Cell Identifier, PCI, to the target cell associated with a second PCI, and
a signaling multiplexed with mobility signaling indicating a change from the source cell to the target cell.

29. The wireless device of claim 27, wherein the wireless device is adapted to perform a random access using the determined RACH configuration.

30. The wireless device of claim 29, wherein the wireless device is adapted to start a timer upon receiving the plurality of RAC configurations, and wherein the determined RACH configuration is used until the timer expires.

31. The wireless device of claim 29, wherein when performing the random access using the determined RACH configuration, the wireless device is adapted to:
determine that at least one condition is fulfilled; and
based on the at least one condition being fulfilled, use the determined RACH configuration.

32. The wireless device of claim 31, wherein when determining that the at least one condition is fulfilled, the wireless device is adapted to determine that a timer associated with the determined RACH configuration is running.

33. The wireless device of claim 31, wherein the wireless device is adapted to:
determine that the timer associated with the determined RACH configuration has expired; and
determine to cease using the determined RACH configuration.

34. The wireless device of claim 27, wherein the determined RACH configuration comprises at least one parameter that is applicable to the plurality of cells, each of the cells being associated with one or more Physical Cell Identifiers, PCIs.

35. The wireless device of claim 27, wherein the determined RACH configuration comprises at least one parameter that is applicable only to the particular cell that is associated with one or more PCIs.

36. The wireless device of claim 27, wherein the determined RACH configuration comprises at least one parameter that is applicable only to the target cell that is associated with one or more PCIs.

37. The wireless device of claim 27, wherein the plurality of RACH configurations are received via a Radio Resource Control, RRC, message.

38. The wireless device of claim 27, wherein the wireless device is adapted to perform at least one of:
receive a change to at least a portion of the determined RACH configuration;
receive a change to an association between at least a portion of the determined RACH configuration and a cell or a Physical Cell Identifier, PCI; and
receive a change to an association between at least a portion of the determined RACH configuration and a parameter or an information element.

39. The wireless device of claim 27, wherein the indication of the change from the source cell to the target cell is received as a Medium Access Control-Control Element, MAC CE.

40. The wireless device of claim 39, wherein the MAC CE comprises a cell identifier associated with a new target cell, and the wireless device is adapted to:
determine a new RACH configuration among the plurality of RACH configurations associated with the new target cell; and
switch from the target cell to the new target cell.

41. The wireless device of claim 39, wherein the MAC CE comprises a RACHConfigID associated with a new target cell to which the wireless device performs Layer 1 or Layer 2 mobility.

42. The wireless device of claim 39, wherein the MAC CE comprises a mobilityCellID and the RACHConfigID, and the wireless device is adapted to update an association between the mobilityCellID and the RACHConfigID.

43. The wireless device of claim 27, wherein the wireless device determines not to perform random access when a Time Alignment, TA, timer is running, and the wireless device is adapted to:
upon receiving an indication to perform the Layer 1 or Layer 2 mobility, initiate monitoring of a physical downlink control channel, PDCCH, and/or Control Resource Set, CORESET, according to an indicated Transmission Configuration Identifier, TCI, state.

44. The wireless device of claim 43, wherein the wireless device determines to perform random access when the TA timer has expired, and the wireless device is further adapted to:
upon receiving an indication to perform the Layer 1 or Layer 2 mobility, perform random access with the determined RACH configuration.

45. A network node adapted to:
transmitting, to a wireless device, a plurality of random access channel, RACH, configurations, each RACH configuration being associated with a cell within a plurality of cells that are configured as target candidate cells for Layer 1 or Layer 2 mobility; and transmit, to the wireless device via Layer 1 or Layer 2 signaling, an indication of a change from a source cell to a target cell, wherein the indication enables the wireless device to determine, among the plurality of RACH configurations, a RACH configuration associated with the target cell.

46. The network node of claim 45, wherein at least one RACH configuration within the plurality of RACH configurations comprises at least one parameter that is applicable to the plurality of cells, each of the cells being associated with one or more physical cell identifiers, PCIs.

47. The network node of claim 45, wherein at least one RACH configuration within the plurality of RACH configurations comprises at least one parameter that is applicable only to the target cell that is associated with one or more Physical Cell Identifiers, PCIs.

48. The network node of claim 45, wherein the plurality of RACH configurations are transmitted in a Radio Resource Control message, a Medium Access Control message, and/or a Medium Access Control-Control Element.

49. The network node of claim 45, further adapted to transmit, to the wireless device, at least one of:
a change to at least a portion of at least one RACH configuration;
a change to an association between at least a portion of at least one RACH configuration and a cell or a Physical Cell Identifier, PCI; and
a change to an association between at least a portion of at least one RACH configuration and a parameter or an information element.

50. The network node of claim 45, wherein the indication of the change from the source cell to the target cell is transmitted via a Medium Access Control—Control Element, MAC CE.

51.-53. (canceled)
